(19) United States
(12) Patent Application Publication
(10) Pub. No.: US 2016/0297602 A1
(43) Pub. Date: Oct. 13, 2016

(54) Swipe Assist Bag for a Magnetic Stripe Card

(71) Applicant: Vernon Dwain Hutchins, Carencro, LA (US)

(72) Inventor: Vernon Dwain Hutchins, Carencro, LA (US)

(21) Appl. No.: 15/003,680

(22) Filed: Jan. 21, 2016

Related U.S. Application Data
(60) Provisional application No. 62/145,802, filed on Apr. 10, 2015.

(51) Int. Cl. B65D 85/38; G06K 19/06; G06K 19/04

(52) U.S. Cl. CPC B65D 85/38; G06K 19/042; G06K 19/06187

(57) ABSTRACT

A swipe assist bag for a magnetic stripe card which facilitates proper reading by a card reader. The swipe assist bag includes a first film, a second film, and a first storage hole. The first film and the second film act as physical spacers for the magnetic stripe card and are adjacently positioned to each other; additionally, each comprise a first edge and a second edge. The first edge is positioned adjacent and perpendicular to the second edge to create an L-shape. The first edge of the first film and the first edge of the second film are adjacently connected along each other. Similarly, the second edge of the first film and the second edge of the second film being adjacently connected along each other in order to create a pocket cavity for the magnetic stripe card. The first storage hole traverses through the first film.

The current application claims a priority to the U.S. Provisional Patent application Ser. No. 62/145,802 filed on Apr. 10, 2015.

### FIELD OF THE INVENTION

The present invention relates generally to accessories for magnetic stripe cards and card machines. More specifically, the present invention is a swipe assist bag for a magnetic stripe card which aids in proper reading by card machines.

### BACKGROUND OF THE INVENTION

A magnetic stripe card is a device for storing data in the form of a handheld card. The magnetic stripe card utilizes a magnetic band to store and convey said data. The magnetic band is composed of iron-based magnetic particles that are distributed and bound within a plastic medium. The magnetic band comprises two types of regions, a magnetized region and a non-magnetized region. These regions are used to encode information, most often times personal and confidential information. A card reader detects the changes in magnetic fields associated with these regions in order to extract the information stored on the magnetic stripe card. In today's society, the most prevalent use of magnetic stripe cards is in the form of a credit card, a magnetic stripe card which contains banking and financial information.

While the magnetic band is composed of a plastic medium, it is susceptible to data corruption and distortion if it is exposed to a strong magnet or physical damage. Additionally, extended use of the magnetic stripe card can cause physical damage. Wear and tear from simply storing the magnetic stripe card in a wallet can cause distortion in the magnetic particles within the magnetic band. Most often times, damage to the magnetic band comes in the form of smearing. Smearing is when magnetic particles migrate from a magnetized region into a non-magnetized region and cause a weak magnetic signal, which distorts the information read by the card reader resulting in the card being declined. The present invention provides a quick and simple solution to this problem. The present invention acts as a spacer in between the magnetic band and the card reader. This causes the card reader to register the corrupt regions as non-magnetized regions once again because a magnetic field decreases in amplitude as the distance increases. The decrease in signal is significant because the strength of the corrupted region was small from the beginning.

### BRIEF DESCRIPTION OF THE DRAWINGS

FIG. 1 is a perspective view of the present invention.

FIG. 2 is a perspective view of an alternative embodiment of the present invention.

FIG. 3 is an exploded perspective view of the present invention.

FIG. 4 is a right side-view of the first film.

FIG. 5 is a left side-view of the second film.

FIG. 6 is a perspective view of an alternative embodiment of the present invention.

FIG. 7 is a right side-view of an alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention is an accessory for magnetic stripe cards and card readers. More specifically, the present invention is a swipe assist bag for magnetic stripe cards and card readers which increases the chances of correct reading even if the magnetic stripe card is corrupt or damaged to a certain degree.

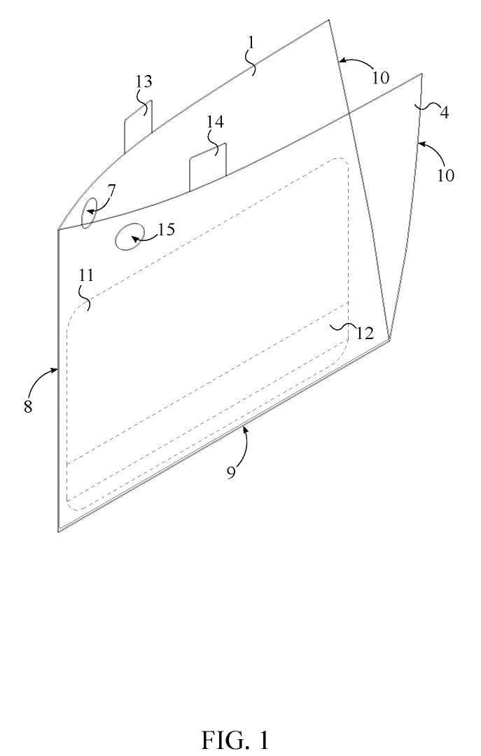

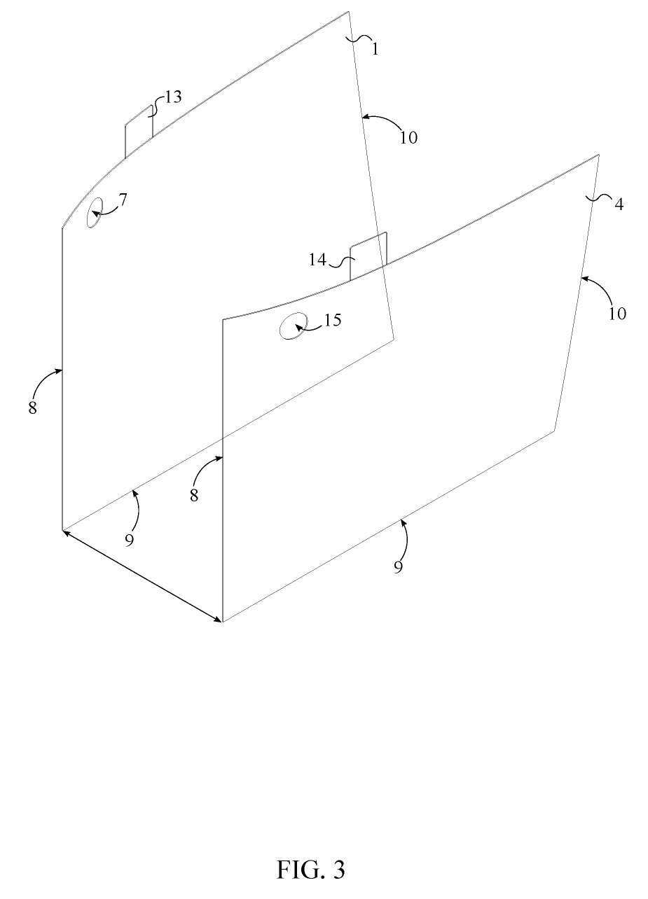

In general, the system for accurately reading a magnetic stripe card 11 with the swipe assist bag is achieved by creating an offset distance between a magnetic band 12 of the magnetic stripe card 11 and a card reader. The offset distance diminishes the magnetic signal produced by corrupt regions of the magnetic band 12, resulting in the successful reading of data stored on the magnetic stripe card 11. Referring to FIG. 1, the present invention comprises a first film 1, a second film 4, a first storage hole 7, and a second storage hole 15. The first film 1 and the second film 4 act as physical spacers for a first flat surface and a second flat surface of the magnetic stripe card 11. The first film 1 and the second film 4 are preferably identical in shape, design, and material composition as seen in FIG. 3; although, alternative embodiments of the present invention may differ in order to accommodate user needs. The first film 1 is adjacently positioned to the second film 4; the first film 1 and the second film 4 each comprise a first edge 8 and a second edge 9. The first edge 8 is positioned adjacent and perpendicular to the second edge 9 in order to create an L-shaped corner. The first edge 8 of the first film 1 and the first edge 8 of the second film 4 are adjacently connected along each other resulting in a first seam-like structure. In a similar fashion, the second edge 9 of the first film 1 and the second edge 9 of the second film 4 are adjacently connected along each other to create a second seam-like structure. The first seam-like structure and the second seam-like structure may be accomplished through a variety of manufacturing processes including, but not limited to, heat sealing, ultrasonic sealing, and lamination. The first second seam-like structure, the second seam-like structure, the first film 1, and the second film 4 delineate a pocket cavity that is shaped and sized to receive the magnetic stripe card 11 as seen in FIG. 1.

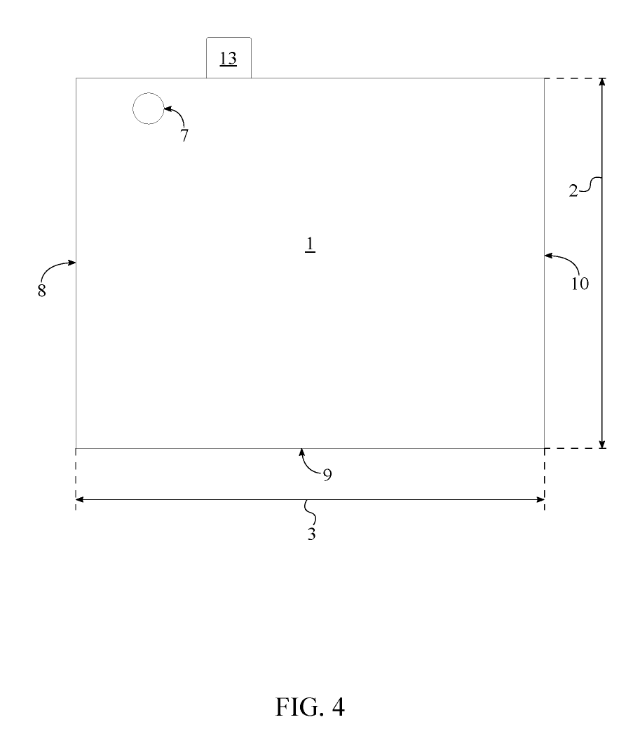

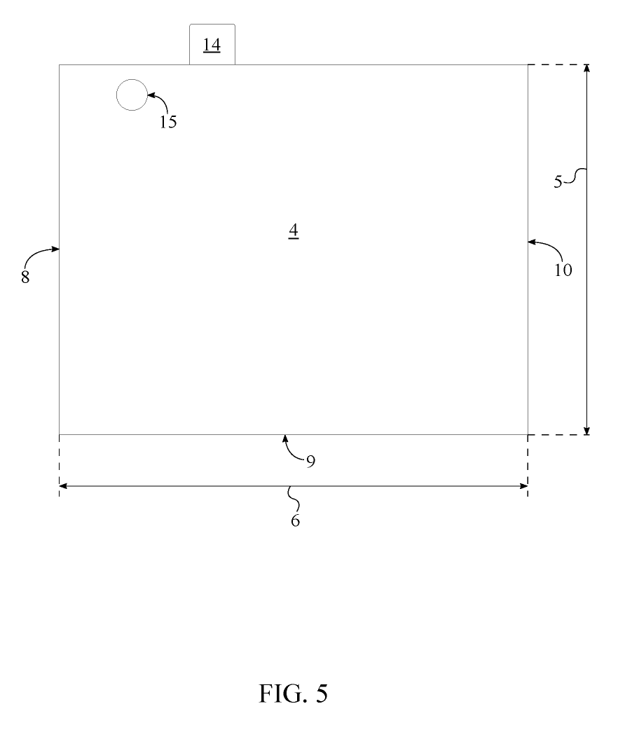

The first storage hole 7 and the second storage hole 15 provides a means for easily dispensing the present invention, similar to existing plastic bags. The first storage hole 7 traverses through the first film 1 while the second storage hole 15 traverses through the second film 4. It is preferred that the second storage hole 15 is positioned coincident with the first storage hole 7. Additionally, the first storage hole 7 and the second storage hole 15 are preferably positioned opposite the second edge 9 of the first film 1 as the magnetic stripe card 11 is to be positioned adjacent to the second seam-like structure. Furthermore, the first storage hole 7 and the second storage hole 15 are circular in shape in order to avoid high stress points, thus preventing accidental tearing and ripping. In an alternative embodiment, the present invention further comprises a first pull tab 13 and a second pull tab 14. More specifically, referring to FIG. 4, the first pull tab 13 is adjacently connected to the first tab, opposite the second edge 9 of the first film 1. Similarly, referring to FIG. 5, the second pull tab 14 is adjacently connected to the second film 4, opposite the second edge 9 of the second film 4. The first pull tab 13 and the second pull tab 14 provide an alternative means for easily dispensing or distributing the present invention. A multitude of instances of the present invention may be stacked on top each other in a storage container with the first pull tab 13 and the second pull tab 14 being exposed outside the container in order to provide the user with a grasping point for each swipe assist bag. In one embodiment of the present invention, the first pull tab 13 and the second pull tab 14 are positioned coincident with each other. In another embodiment of the present invention, the first pull tab 13 and the second tab are positioned offset from each other, thus providing the user with a means for easily separating the first film 1, the second film 4, and opening the pocket cavity.

In the preferred embodiment of the present invention, the first film 1 and the second film 4 are composed of vinyl or polyethylene to create a recyclable, disposable, and environmentally friendly product. In different embodiments of the present invention, the first film 1 and the second film 4 may be composed of alternative materials similar to the aforementioned materials with similar characteristics. To visually aid the user in the proper placement of the magnetic stripe card 11, the first film 1 and the second film 4 are preferably partially or fully transparent. Additionally, the external surfaces of the first film 1 and the second film 4 are preferably smooth to facilitate the flow of the present invention and the magnetic stripe card 11 through the card reader. Referring to FIG. 4 and FIG. 5, a width 2 of the first film 1 and a width 5 of the second film 4 may range between 2.5 inches and 6 inches. Furthermore, a length 3 of the first film 1 and a length 6 of the second film 4 may range between 4 inches and 7 inches. These constrictions ensure that the present invention is large enough to cover and contain the standard magnetic stripe card 11 but not so large that excess material causes a handling problem for the user. Different dimensions for the first film 1 and the second film 4 may also be utilized in alternative embodiments of the present invention.

In order to use the present invention, the user places the magnetic stripe card 11 inside the pocket cavity and slides the present invention and the magnetic stripe card 11 through the card reader. More specifically, the ideal position for the magnetic stripe card 11 is in between the first film 1 and the second film 4, parallel to the first film 1 as seen in FIG. 1. Furthermore, it is necessary that the magnetic band 12 of the magnetic stripe card 11 is positioned adjacent to the second edge 9 such that the second edge 9 and the magnetic band 12 slide through the card reader.

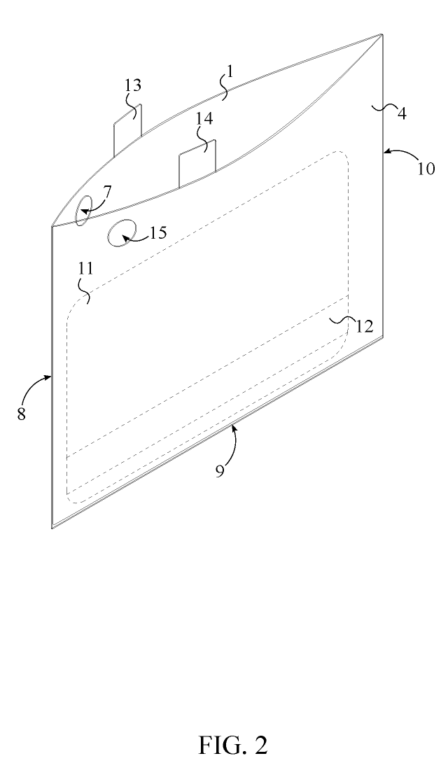

In an alternative embodiment of the present invention, the first film 1 and the second film 4 each further comprise a third edge 10. The third edge 10 is positioned adjacent and perpendicular to the second edge 9, opposite the first edge 8. The third edge 10 of the first film 1 and the third edge 10 of the second film 4 are adjacently connected along each other to create a third seam-like structure as seen in FIG. 2. This results in a partially rectangular design, a mirror of the standard shape and design of the magnetic stripe card. The third seam-like structure ensures that the magnetic stripe card 11 stays fully covered by the first film 1 and the second film 4 during usage/reading.

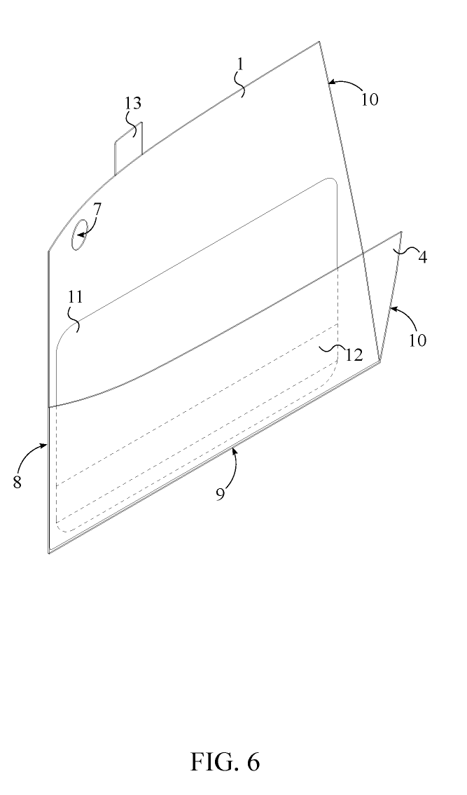

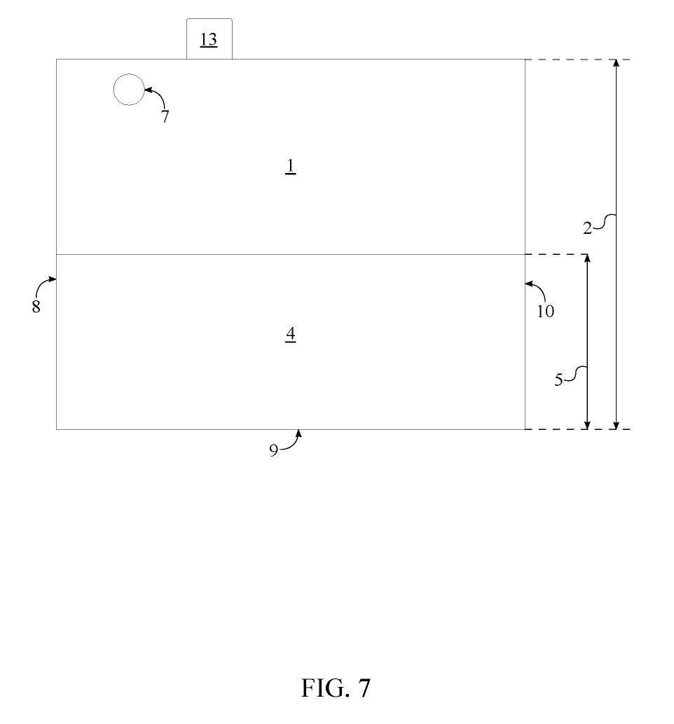

Referring to FIG. 6 and FIG. 7, in one embodiment of the present invention, the width 5 of the second film 4 is less than half the width 2 of the first film 1. When the magnetic stripe card 11 is placed within the present invention, this offset distance exposes a portion of the magnetic stripe card 11 outside the second film 4, allowing the user to easily remove the magnetic stripe card 11 after swiping through the card reader. In this embodiment, the second storage hole 15 and the second pull tab 14 are not present nor are they necessary.

Although the invention has been explained in relation to its preferred embodiment, it is to be understood that many other possible modifications and variations can be made without departing from the spirit and scope of the invention as hereinafter claimed.

What is claimed is:

1. A swipe assist bag for a magnetic stripe card comprises:
a first film;
a second film;
a first storage hole;
the first film and the second film each comprise a first edge and a second edge;
the first edge being positioned adjacent and perpendicular to the second edge;
the first film being adjacently positioned to the second film;
the first edge of the first film and the first edge of the second film being adjacently connected along each other;
the second edge of the first film and the second edge of the second film being adjacently connected along each other; and
the first storage hole traversing through the first film.

2. The system for accurately reading the magnetic stripe card with the swipe assist bag as claimed in claim 1 comprises:
a magnetic stripe card;
the magnetic stripe card being oriented parallel to the first film;
the magnetic stripe card being positioned in between the first film and the second film; and
a magnetic band of the magnetic stripe card being positioned adjacent to the second edge of the first film.

3. The swipe assist bag for a magnetic stripe card as claimed in claim 1 comprises:
the first film and the second film each further comprise a third edge;
the third edge being positioned adjacent and perpendicular to the second edge, opposite the first edge; and
the third edge of the first film and the third edge of the second film being adjacently connected along each other.

4. The swipe assist bag for a magnetic stripe card as claimed in claim 1 comprises:
a first pull tab; and
the first pull tab being adjacently connected to the first film, opposite the second edge of the first film.

5. The swipe assist bag for a magnetic stripe card as claimed in claim 4 comprises:
a second storage hole;
a second pull tab;
the second pull tab being adjacently connected to the second film, opposite the second edge of the second film;
the first pull tab and the second pull tab being positioned coincident with each other;
the second storage hole being positioned coincident with the first storage hole; and
the second storage hole traversing through the second film.

6. The swipe assist bag for a magnetic stripe card as claimed in claim 1 comprises:
a second storage hole;
a second pull tab;
the second pull tab being adjacently connected to the second film, opposite the second edge of the second film;
the second storage hole being positioned coincident with the first storage hole; and
the second storage hole traversing through the second film.

7. The swipe assist bag for a magnetic stripe card as claimed in claim 6 comprises:
a first pull tab;
the first pull tab being adjacently connected to the first film, opposite the second edge of the first film; and
the first pull tab and the second pull tab being positioned coincident with each other.

8. The swipe assist bag for a magnetic stripe card as claimed in claim 1, wherein the first film and the second film are composed of vinyl.

9. The swipe assist bag for a magnetic stripe card as claimed in claim 1, wherein the first film and the second film are composed of polyethylene.

10. The swipe assist bag for a magnetic stripe card as claimed in claim 1, wherein a width of the first film and a width the second film ranges between 2.5 inches and 6 inches.

11. The swipe assist bag for a magnetic stripe card as claimed in claim 1, wherein a width of the second film is less than half a width the first film.

12. The swipe assist bag for a magnetic stripe card as claimed in claim 1, wherein a length of the first film and a length of the second film ranges between 4 inches and 7 inches.

13. A swipe assist bag for a magnetic stripe card comprises:
a first film;
a second film;
a first storage hole;
the first film and the second film each comprise a first edge, a second edge, and a third edge;
the first edge being positioned adjacent and perpendicular to the second edge;
the first film being adjacently positioned to the second film;
the first edge of the first film and the first edge of the second film being adjacently connected along each other;
the second edge of the first film and the second edge of the second film being adjacently connected along each other;
the third edge being positioned adjacent and perpendicular to the second edge, opposite the first edge;
the third edge of the first film and the third edge of the second film being adjacently connected along each other; and
the first storage hole traversing through the first film.

14. The system for accurately reading the magnetic stripe card with the swipe assist bag as claimed in claim 13 comprises:
a magnetic stripe card;
the magnetic stripe card being oriented parallel to the first film;
the magnetic stripe card being positioned in between the first film and the second film; and
a magnetic band of the magnetic stripe card being positioned adjacent to the second edge of the first film.

15. The swipe assist bag for a magnetic stripe card as claimed in claim 13 comprises:
a first pull tab; and
the first pull tab being adjacently connected to the first film, opposite the second edge of the first film.

16. The swipe assist bag for a magnetic stripe card as claimed in claim 15 comprises:
a second storage hole;
a second pull tab;
the second pull tab being adjacently connected to the second film, opposite the second edge of the second film;
the first pull tab and the second pull tab being positioned coincident with each other;
the second storage hole being positioned coincident with the first storage hole; and
the second storage hole traversing through the second film.

17. The swipe assist bag for a magnetic stripe card as claimed in claim 13, wherein a width of the first film and a width the second film ranges between 2.5 inches and 6 inches.

18. The swipe assist bag for a magnetic stripe card as claimed in claim 13, wherein a width of the second film is less than half a width the first film.

19. The swipe assist bag for a magnetic stripe card as claimed in claim 13, wherein a length of the first film and a length of the second film ranges between 4 inches and 7 inches.
